(19) United States
(12) Patent Application Publication
(10) Pub. No.: US 2008/0222732 A1
(43) Pub. Date: Sep. 11, 2008

(54) Computer manufacturer and software installation detection

(75) Inventors: Gary Caldwell, Redmond, WA (US); Satish Shetty, Redmond, WA (US); Alexander Weil, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/714,594

(22) Filed: Mar. 6, 2007

(51) Int. Cl. G06F 7/04; G06F 9/445

(52) U.S. Cl. 726/26; 717/174

(57) ABSTRACT

Detailed herein is a technology which, among other things, allows the manufacturer of a computer system to be identified. In one approach to the technology, a method of determining the manufacturer of a computer is described. The method involves accessing a collection of manufacturer identification code information. The method also involves reading a specific manufacturer identification code from the computer. The method calls for comparing the specific manufacturer identification code with the collection of manufacturer identification code information, to determine the manufacturer of the computer.

In the computer industry, it is relatively common for a software manufacturer to partner with an original equipment manufacturer (OEM), in order to include their software on the computer system being manufactured and sold by the OEM. In some situations, the software in question may be relatively expensive, if purchased at retail, or complicated for a typical consumer to install or configure on their own after purchasing the computer.

One approach to ensuring software authenticity, and hindering software piracy, is to require post-installation authentication of software package, such as requiring the software to contact the software manufacturer to activate software. In some situations, an OEM will contract with the software manufacturer for a special “key” or authentication identifier that can be included in the initial installation of the software, to pre-authenticate the software, without the need for the consumer to go through the activation process. This can be referred to as system-locked preinstallation (SLP), where the software is pre-activated for use on that particular piece of equipment.

The keys used for the OEM SLP process need to be tightly controlled, because possession of such a key allows for the software to be installed on any number of machines without the need for activation. The software manufacturer must rely on the OEM, and all of the OEM's employees, to properly secure the SLP key. The software manufacturer cannot easily determine how many installations using a particular SLP key has been made, nor whether the SLP key is used only on software installed on the OEM's products.

### SUMMARY

Detailed herein is a technology which, among other things, allows the manufacturer of a computer system to be identified. In one approach to the technology, a method of determining the manufacturer of a computer is described. The method involves accessing a collection of manufacturer identification code information. The method also involves reading a specific manufacturer identification code from the computer. The method calls for comparing the specific manufacturer identification code with the collection of manufacturer identification code information, to determine the manufacturer of the computer.

In another approach to the technology, a computer-readable medium having computer-executable instructions is described. In this approach, a collection of software installation authentication information is accessed. A specific software activation key is read, associated with a particular software installation on the computer. A specific manufacturer identification code for the computer is also read. The specific software activation key and the specific manufacturer identification code are compared with the collection of software installation authentication information, to determine whether the software installation is valid.

Another approach describes a system for authenticating software installation. A system has a bus, processor, firmware, memory, and a data storage device. The system is configured to compare a manufacturer identification code, stored in the firmware, with a collection of manufacturer identification code information, to determine the manufacturer of the system.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE FIGURES

The accompanying drawings, which are incorporated in and form a part of this specification, illustrate embodiments and, together with the description, serve to explain the principles of the claimed subject matter:

FIG. 1 is a block diagram of an example computer system, in accordance with one embodiment.

FIG. 2 is a topographical view of a computing system, in accordance with one embodiment.

FIG. 3 is an authentication network, in accordance with one embodiment.

FIG. 4 is a flowchart of a method of determining the manufacturer of an OEM computer, in accordance with one embodiment.

FIG. 5 is a flowchart of a method of detecting legitimate software installation, in accordance with one embodiment.

FIG. 6 is a flowchart of a method of detecting a potentially valid software installation, in accordance with one embodiment.

### DETAILED DESCRIPTION

Reference will now be made in detail to several embodiments. While the subject matter will be described in conjunction with the alternative embodiments, it will be understood that they are not intended to limit the claimed subject matter to these embodiments. On the contrary, the claimed subject matter is intended to cover alternative, modifications, and equivalents, which may be included within the spirit and scope of the claimed subject matter as defined by the appended claims.

Furthermore, in the following detailed description, numerous specific details are set forth in order to provide a thorough understanding of the claimed subject matter. However, it will be recognized by one skilled in the art that embodiments may be practiced without these specific details or with equivalents thereof. In other instances, well-known methods, procedures, components, and circuits have not been described in detail as not to unnecessarily obscure aspects and features of the subject matter.

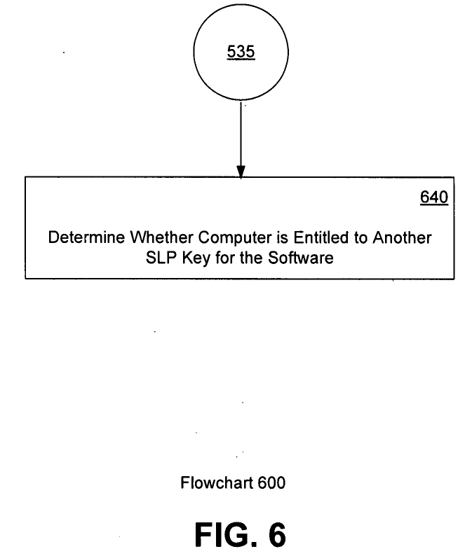

Portions of the detailed description that follows are presented and discussed in terms of a method. Although steps and sequencing thereof are disclosed in a figure herein (e.g., FIG. 6) describing the operations of this method, such steps and sequencing are exemplary. Embodiments are well suited to performing various other steps or variations of the steps recited in the flowchart of the figure herein, and in a sequence other than that depicted and described herein.

Some portions of the detailed description are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “accessing,” “writing,” “including,” “storing,” “transmitting,” “traversing,” “associating,” “identifying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Computing devices typically include at least some form of computer readable media. Computer readable media can be any available media that can be accessed by a computing device. By way of example, and not limitation, computer readable medium may comprise computer storage media and communication media. Computer storage media includes volatile and nonvolatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other medium which can be used to store the desired information and which can be accessed by a computing device. Communication media typically embodies computer readable instructions, data structures, program modules, or other data in a modulated data signals such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media.

Some embodiments may be described in the general context of computer-executable instructions, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

### Identifying OEM Computers

In the embodiments below, an approach is described which allows for the identification of an OEM supplier of a computer system. Further, several of these embodiments allow identification of improperly authenticated software, e.g., where an OEM's SLP key has been used to install software on a computer not licensed for the SLP key, or where an OEM computer, entitled to usage of the software under one SLP key, is using a different installation.

As described in greater detail below, in some embodiments, an OEM identification tag (OEM ID) is included in the system firmware. By reading this OEM ID from the system firmware, and comparing it with a listing of known OEM IDs, the manufacturer, and sometimes the specific model, of the computer can be determined. Further, in several such embodiments, the SLP key for piece of software can be read from the computer as well, e.g., from system registry. A listing of OEMs and SLP key pairings can be referenced, and a determination can be made, as to whether the computer is authorized to be running the software using that particular SLP key. Moreover, in several embodiments, it is possible to identify a computer which is entitled to be running a copy of the software under a particular SLP key, but has a different SLP key.

Embodiments utilizing the below described approaches provide numerous advantages. Among them, it is possible to identify breaches in the OEM SLP process, where an SLP key intended for a specific OEM and/or computer model are being used on other products. Moreover, it is possible to identify computers which are entitled to be using a particular installation of the software, but have ended up with an unauthenticated installation, e.g., such as where a computer repair shop has reinstalled the software from another source, rather than reinstalling the computer's original software. In such a situation, these embodiments make it possible for the legitimate consumer to be protected from automated antipiracy approaches.

### Exemplary Computer System

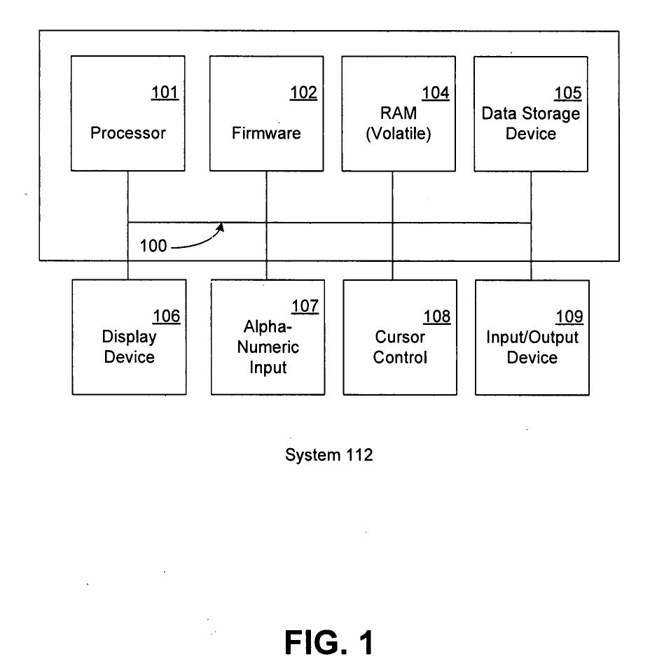

With reference now to FIG. 1, an example computer system 100 is depicted, in accordance with one embodiment. It is appreciated that computer system 100 described herein illustrates an exemplary configuration of an operational platform upon which embodiments of the present invention can be implemented. Nevertheless, other computer systems with differing configurations can also be used in place of computer system 100 within the scope of the present invention. That is, computer system 100 can include elements other than those described in conjunction with FIG. 1.

Computer system 112 includes an address/data bus 100 for communicating information, a central processor 101 coupled with bus 100 for processing information and instructions; a volatile memory unit 104 (e.g., random access memory [RAM], static RAM, dynamic RAM, etc.) coupled with bus 100 for storing information and instructions for central processor 101; and a firmware unit 102 (e.g., non-volatile read only memory [ROM], programmable ROM, flash memory, etc.) coupled with bus 100 for storing static information and instructions, such as basic input/output system (BIOS) 103, for processor 101. Computer system 112 may also contain an optional display device 106 coupled to bus 100 for displaying information to the computer user. Moreover, computer system 112 also includes a data storage device 105 (e.g., disk drive) for storing information and instructions. In some embodiments, an interconnect or other component communications protocol is utilized, in addition to or in place of bus 100. Moreover, in some embodiments, system 112 may comprise multiple processors 101, and/or a processor 101 may include multiple programmatic cores.

Also included in computer system 112 is an optional alphanumeric input device 107. Device 107 can communicate information and command selections to central processor 101. Computer system 112 also includes an optional cursor control or directing device 108 coupled to bus 100 for communicating user input information and command selections to central processor 101. Computer system 112 also includes signal communication interface (input/output device) 109, which is also coupled to bus 100, and can be a serial port. Communication interface 109 may also include wireless communication mechanisms. Using communication interface 108, computer system 112 can be communicatively coupled to other computer systems over a communication network such as the Internet, intranet (e.g., a local area network), wireless network, or wireless mesh network.

### Computer Topography

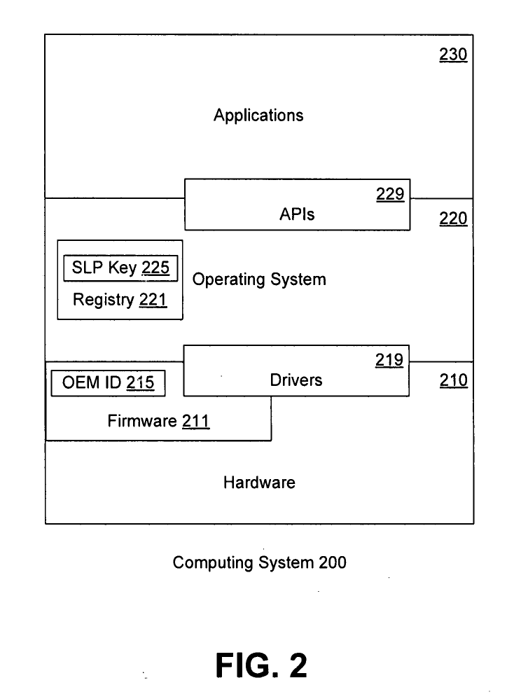

With reference now to FIG. 2, a topographical view of a computing system 200 is depicted, in accordance with one embodiment. While computing system 200 is shown to have specific, enumerated features and elements, it is understood that embodiments are well suited to applications having fewer, additional, or different features, elements, or organization.

As shown in FIG. 2, the organization of computing system 200 can be viewed as a series of interacting layers, building on top of the underlying hardware layer, hardware layer 210. Residing on top of hardware layer 210, and, in some embodiments, integrated into components supplied with the hardware is firmware layer 211. In some embodiments, firmware layer 211 includes computing system 200's basic input/output system (BIOS). Additionally, in the depicted embodiment, firmware layer 211 includes an OEM identifier (OEM ID) 215. In some embodiments, OEM ID 215 is at a specific location in the firmware, and contains data which identifies the OEM that manufactured computing system 200, and in some embodiments, the specific OEM model number of computing system 200.

As depicted in FIG. 2, an operating system layer, OS layer 220, resides on top of firmware layer 211. Interaction between OS layer 220 and firmware layer 211 or hardware layer 210 is managed by software drivers 219. In the depicted embodiment, OS layer 220 includes a system registry 221; system registry 221, in some embodiments, stores information regarding the operating system itself, as well as applications, drivers, and hardware installed on computing system 200. In the depicted embodiment, system registry 221 includes SLP key 225.

Residing on top of OS layer 220 is application layer 230, in the depicted embodiment. Application layer 230 interacts with OS layer 220 by means of application programming interfaces, such as API 229.

An SLP key, such as SLP key 225, is used when an OEM preinstalls software which would ordinarily require user activation after installation. The SLP key allows the OEM to sell the computer with the software already activated. In some embodiments, an SLP key is specific to a particular OEM; in several such embodiments, the SLP key is specific both to the OEM and the model of the computer. An SLP key may be used for any piece of software; moreover, a computer may have multiple pieces of software installed, each with their own SLP keys. The SLP key could be stored anywhere in the computer; in the depicted embodiment, the SLP key is stored in the system registry.

### OEM and SLP Key Pairings

In some embodiments, it is possible for the software manufacturer to track the usage of their issued SLP keys, without requiring the user to go through an activation process, which the SLP key system was implemented to avoid. By keeping track of the OEM IDs for the OEMs, and potentially individual system models, to which a particular SLP key has been issued, the software manufacturer can establish a list or database of OEM/SLP key pairings. In some embodiments, a program can be run on a computer, which checks the software's SLP key against the computer's OEM ID. If there is a mismatch, the SLP key is not authorized for use on that computer.

In some embodiments, such a validity check may occur regularly, e.g., when the system is powered on, or when the operating system or program loads. In other embodiments, this approach is coupled with another event, e.g., an event requiring authentication of the validity of the software, such as downloading or installing a patch or update for the software. In some embodiments, this validity check may be completed by the system itself; in other embodiments, a validity check may involve transmitting both the OEM ID and the SLP key to a remote server, e.g., one which maintains the OEM/SLP key database. Further, in some embodiments, some or all of the results of this validity check may be passed to a remote server.

### Authentication Network

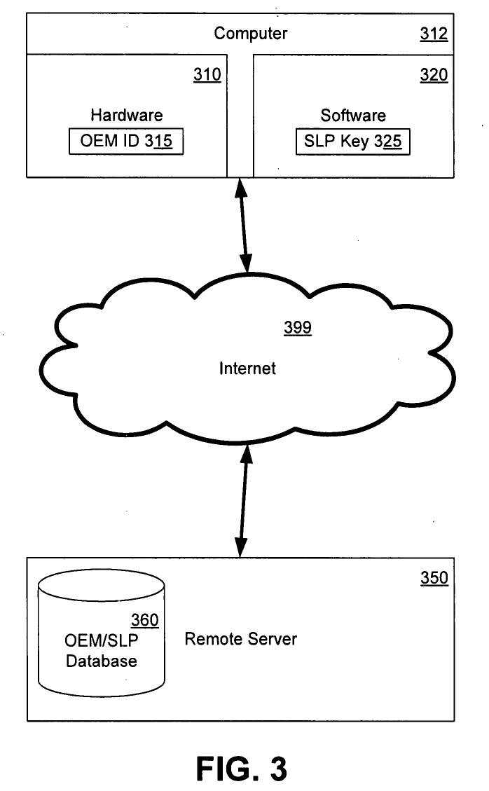

With reference now to FIG. 3, an authentication network 300 is depicted, in accordance with one embodiment. While authentication network 300 is shown to have specific, enumerated features and elements, it is understood that embodiments are well suited to applications having fewer, additional, or different features, elements, or organization.

As shown, authentication network 300 includes computer 312. In the depicted embodiment, computer 312 includes hardware components 310, and software 320. Included in hardware components 310 is an OEM ID 315; in the depicted embodiment, OEM ID 315 identifies both the manufacturer and the model of computer 312. Software 320, as shown, includes SLP key 325; in the depicted embodiment, SLP key 325 is associated with software 320, and allows use of software 320 without needing to go through an activation process.

Authentication network 300 is also shown as including remote server 350. Remote server 350 includes OEM/SLP key database 360. In the depicted embodiment, OEM/SLP key database 360 contains information regarding which OEM is entitled to use which SLP key, for which model of computer. In some embodiments, OEM/SLP key database 360 may also contain information regarding where each OEM ID may be located in the system firmware for each model of computer. In other embodiments, this information may be stored in other locations.

In the depicted embodiment, computer 312 is shown as communicating with remote server 350 by means of connection to Internet 399.

### Determining the Manufacturer of an OEM Computer

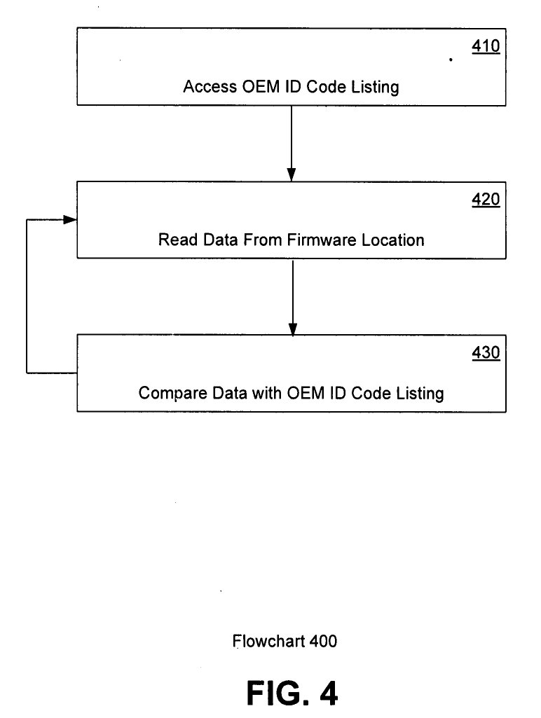

With reference now to FIG. 4, a flowchart 400 of a method of determining the manufacturer of an OEM computer is depicted, in accordance with one embodiment. Although specific steps are disclosed in flowchart 400, such steps are exemplary. That is, embodiments of the present invention are well suited to performing various other (additional) steps or variations of the steps recited in flowchart 400. It is appreciated that the steps in flowchart 400 may be performed in an order different than presented, and that not all of the steps in flowchart 400 may be performed.

With reference now to step 410, a listing of OEM ID codes is accessed. In some embodiments, as described above, an OEM will include an identification code in the firmware of the computer. The information contained in this OEM ID may vary, across different embodiments. In some embodiments, the OEM ID identifies a manufacturer of the computer. In some embodiments, the OEM ID also identifies the model of the computer. In different embodiments, the location of this OEM ID may vary; different OEMs may put the OEM ID at different locations in the system firmware, and an OEM may put an OEM ID at a different location in system firmware, depending on the model of the computer. Moreover, the format of the OEM ID may vary, across different embodiments.

In some embodiments, this listing of OEM ID codes includes a location in system firmware where each such code would be found, as well as the expected data that will be found in that location. For example, for a specific OEM and a specific model of computer, the OEM ID would be found at a first specified address in the system firmware, and have a first specified format. For a second OEM and a second model of computer, the OEM ID would be found at a different, second specified address on system firmware, and have a different, second specified format.

With reference now to step 420, data is read from a location in the system's firmware. In some embodiments, in order to locate an OEM ID code, it may be necessary to check all possible locations that an OEM ID code may be stored. For example, if a program is attempting to determine the OEM ID of a particular computer, it may be necessary for the program to read some or all of the potential locations in the system's firmware, and compare the data stored at those locations with a list or database of known OEM IDs. In other embodiments, other approaches are utilized.

With reference now to step 430, the data read from the system firmware is compared against the list of OEM ID codes. In some embodiments, this comparison allows the determination of whether the data matches an OEM ID.

In some embodiments, the method calls for steps 420 and 430 to cycle, such that multiple locations on system firmware are compared against the list of OEM ID codes. In some embodiments, this repeated comparison may result in zero or more matches. In some embodiments, if there are zero matches, the computer may not have been manufactured by an OEM, or may have been manufactured using an OEM ID that does not appear on the list. In some embodiments, if there is exactly one match, the computer may have been manufactured by the OEM linked with that particular OEM ID. In some embodiments, if there is more than one match, a single OEM may have placed multiple OEM identifiers in the computer's firmware, or several OEMs may have supplied portions of the computer, or the computer's firmware may have been altered. In other embodiments, other situations or scenarios may apply.

For example, with reference to FIG. 3, computer 312 may access OEM/SLP key database 360, stored on remote server 350. From database 360, location and content information for each possible OEM ID is obtained. Each potential location of an OEM ID is read from the firmware of system 312, and compared against the location and content information obtained from database 360. When OEM ID 315 is read, and compared against database 360, the manufacturer and model of computer 312 can be determined.

### Detecting Legitimate Software Installation

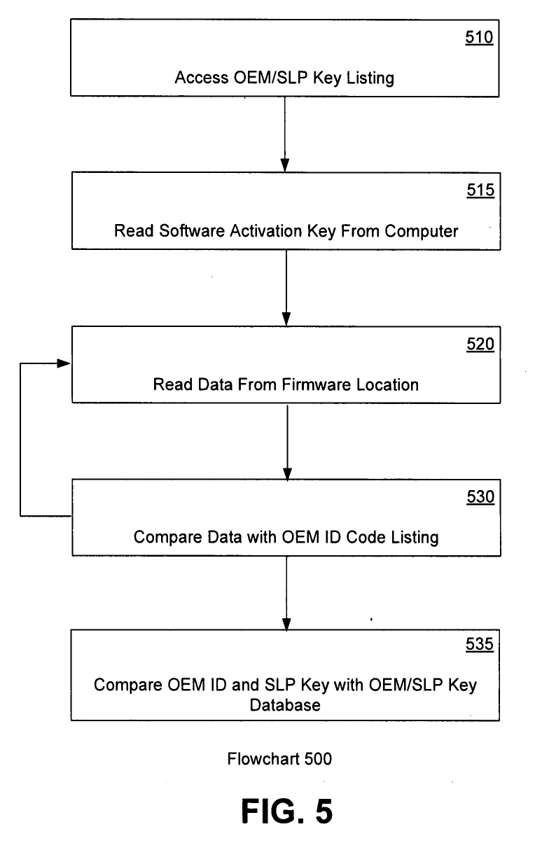

With reference now to FIG. 5, a flowchart 500 of a method of detecting legitimate software installation is depicted, in accordance with one embodiment. Although specific steps are disclosed in flowchart 500, such steps are exemplary. That is, embodiments of the present invention are well suited to performing various other (additional) steps or variations of the steps recited in flowchart 500. It is appreciated that the steps in flowchart 500 may be performed in an order different than presented, and that not all of the steps in flowchart 500 may be performed.

With reference to step 510, a list of OEM ID codes and software activation keys is accessed. In some embodiments, a software activation key, e.g., an SLP key, is provided to ant OEM computer manufacturer or distributor, in order to allow them to install and activate certain software, before selling the system. In some embodiments, a database is utilized, which contains pairs of OEM ID codes and SLP keys, indicating which OEM ID code or codes a particular SLP key is associated with. Further, in some embodiments, the list also contains location and format information for some or all of the OEM ID codes, e.g., expected address in the system's firmware, as well as expected contents of that address.

With reference to step 515, a software activation key is read from the computer. In some embodiments, the software activation key is associated with software installed on the computer. In some embodiments, the software activation key will be stored in a known location, e.g., the operating system registry for the computer.

With reference to step 520, data is read from a location in the system's firmware. In some embodiments, in order to locate an OEM ID code, it may be necessary to check all possible locations that an OEM ID code may be stored. For example, if a program is attempting to determine the OEM ID of a particular computer, it may be necessary for the program to read some or all of the potential locations in the system's firmware, and compare the data stored at those locations with a list or database of known OEM IDs. In other embodiments, other approaches are utilized.

With reference to step 530, the data read from the system firmware is compared against the list of OEM ID codes. In some embodiments, this comparison allows the determination of whether the data matches an OEM ID. In some embodiments, the method calls for steps 520 and 530 to cycle, such that multiple locations on system firmware are compared against the list of OEM ID codes.

With reference now to step 535, the OEM ID for the computer, and the software activation key, are referenced against the list of OEM ID codes and software activation keys. In some embodiments, a comparison is made, to determine whether the SLP key and OEM ID of the computer match with the list of OEM/SLP key pairings. If they match, in some embodiments, the software installation on computer may be valid. If they do not match, a software installation on the computer may not be valid. In an alternative embodiment, steps 530 and 535 can be joined, such that the SLP key and the potential OEM ID are referenced against the list of OEM IDs and software activation keys together, rather than first attempting to match the OEM ID.

For example, with reference to FIG. 3, computer 312 may access OEM/SLP key database 360, stored on remote server 350. From database 360, location and content information for each possible OEM ID is obtained. SLP key 325 can be read from software 320. Each potential location of an OEM ID is read from the firmware of system 312, and compared against the location and content information obtained from database 360. When OEM ID 315 is read, and compared against database 360, the manufacturer and model of computer 312 can be determined. OEM ID 315 and SLP key 325 are then compared against OEM/SLP key database 360, to determine whether SLP key 325 is paired with OEM indeed 315.

In some embodiments, the software activation key itself is not stored on the computer; instead, some identifier indicating which software activation key was used is stored, e.g., a hash value generated from the software activation key is preserved on the computer. In several such embodiments, the method described in flowchart 500 is readily adaptable for use with such a software activation key identifier, rather than the key itself. Similarly, the method is readily adaptable for use with encryption and/or compression techniques.

In some embodiments, the results of the method of flowchart 500 can be reported back to the software manufacturer. In different embodiments, this information can be used in different ways. For example, in one embodiment, a software manufacturer may not provide software patches or updates, for systems with invalid software installations. In some embodiments, this process may also identify software authentication keys which have proliferated beyond their original OEM. For example, if a particular SLP key is intended for use only with one particular model of one particular OEM's computer, and the software begins to regularly see that SLP key used with another OEM's computers, it may be possible to identify the source of the leaked SLP key.

### Determining Potential Validity

In some embodiments, it is possible that an OEM manufactured computer may have an invalid installation of software, while being entitled to a valid installation. Such a situation may occur if the original software installation is replaced. For example, if an OEM machine has its software reinstalled by a non-OEM computer repair facility, the repair facility may use an invalid version of the software during the reinstallation. In this matter, a legitimate consumer who is properly licensed to use a legitimate installation of the software may end up with an illegitimate copy. In some embodiments, if the invalid installation is detected, e.g., through the method of flowchart 500, it may be desirable to detect the difference between this scenario, and an illegitimate copy of the software running on a system which was not licensed for any copy of the software.

With reference to FIG. 6, a flowchart 600 of a method of detecting a potentially valid software installation is presented, in accordance with one embodiment. Although specific steps are disclosed in flowchart 600, such steps are exemplary. That is, embodiments of the present invention are well suited to performing various other (additional) steps or variations of the steps recited in flowchart 600. It is appreciated that the steps in flowchart 600 may be performed in an order different than presented, and that not all of the steps in flowchart 600 may be performed.

As depicted, flowchart 600 is a continuation of the method of flowchart 500, beginning after step 535. With reference now to step 640, if it is determined that the software installation may not be valid, it is determined whether the computer is entitled to use a different software activation key for the software. In some embodiments, after determining that the OEM ID and SLP key do not match, the OEM ID, by itself, is compared against the OEM/SLP key database, to determine whether the OEM ID is paired with a different SLP key. If such an alternative pairing exists, it may be that this computer is licensed to use the software, using a different software authentication key.

The method of flowchart 600, in some embodiments, may be beneficial to a legitimate consumer, who has somehow procured an illegitimate software installation. In one embodiment, for example, an automated validity checker may note that, regardless of the SLP key present on the computer, the OEM ID of the computer entitles it to use an installation of the software, and so the automated validity checker allows patches and/or updates as appropriate. Moreover, in some embodiments, if multiple legitimate consumers in the same geographic region have received illegitimate software installations, it may be possible to identify the source of the illegitimate software installations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of determining a manufacturer of a computer, comprising:
accessing a plurality of manufacturer identification code information;
reading a specific manufacturer identification code from said computer; and
comparing said specific manufacturer identification code with said plurality of manufacturer identification code information, to determine said manufacturer of said computer.

2. The method of claim 1, wherein each of said plurality of manufacturer identification code information comprises a manufacturer identification code and a location associated with said manufacturer identification code.

3. The method of claim 2, wherein said reading comprises:
accessing a location associated with one of said plurality of manufacturer identification code information; and
comparing data stored at said location with said manufacturer identification code associated with said one of said plurality of manufacturer identification code information.

4. The method of claim 2, wherein said reading comprises:
accessing every location associated with each of said plurality of manufacturer identification code information; and
for each of said plurality of manufacturer identification code information, comparing data stored at said location with said manufacturer identification code associated with each of said plurality of manufacturer identification code information.

5. The method of claim 2, wherein said location comprises a location in said computer's firmware.

6. A computer-readable medium having computer-executable instructions for performing steps comprising:
accessing a plurality of software installation authentication information;
reading a specific software activation key from a computer, said specific software activation key associated with a first software installation on said computer;
reading a specific manufacturer identification code from said computer; and
comparing said specific software activation key and said specific manufacturer identification code with said plurality of software installation authentication information, to determine whether said software installation is valid.

7. The computer-readable medium of claim 6, wherein each of said plurality of software installation authentication information comprises a manufacturer identification code, a location associated with said manufacturer identification code, and a software activation key associated with said manufacturer identification code.

8. The computer-readable medium of claim 7, wherein said comparing comprises:
comparing said specific software activation key and said specific manufacturer identification code with said manufacturer identification code and said software activation key associated with each of said plurality of software installation authentication information.

9. The computer-readable medium of claim 6, wherein said accessing comprises retrieving said plurality of software installation authentication information from a remote server.

10. The computer-readable medium of claim 6wherein said accessing comprises retrieving said plurality of software installation authentication information from a storage device coupled to said computer.

11. The computer-readable medium of claim 6, wherein said reading said specific software activation key comprises:
accessing a system registry associated with said computer; and
retrieving said specific software activation key from said system registry.

12. The computer-readable medium of claim 6, wherein said reading said specific manufacturer identification code from said computer comprises:
accessing a location associated with one of said plurality of software installation authentication information; and
comparing data stored at said location with said manufacturer identification code associated with said one of said plurality of plurality of software installation authentication information.

13. The computer-readable medium of claim 6, further comprising:
determining whether said computer is authorized for a second software installation associated with a second specific software activation key.

14. The medium of claim 13, wherein said determining is performed if said software installation is not valid.

15. The medium of claim 13, wherein said determining comprises:
comparing said specific manufacturer identification code with a plurality of manufacturer identification codes associated with each of said software installation authentication information; and
determining if said specific manufacturer identification code is associated with any of a plurality of software activation keys associated with each of said software installation authentication information.

16. A system for authenticating software installation, comprising:
a bus;
a processor, coupled to said bus, for processing information;
firmware, coupled to said bus, for storing information, and having a manufacturer identification code stored therein;
a memory, coupled to said bus, for storing information; and
a data storage device, coupled to said bus, for storing information, and having a software program installed thereon, wherein said system is configured to compare said manufacturer identification code with a plurality of manufacturer identification code information, to determine a manufacturer of said system.

17. The system of claim 16, further comprising:
a network interface device, coupled to said bus, for sending and receiving information from a remote server.

18. The system of claim 17, wherein said data storage device also has a software authentication key associated with said software program is stored thereon.

19. The system of claim 18, wherein said system is further configured to compare said manufacturer identification code and said software authentication key with a plurality of software installation authentication information, to determine if said software program is validly installed.

20. The system of claim 19, wherein said system is further configured to transmit a validity result to said remote server.
